(19) United States
(12) Patent Application Publication
(10) Pub. No.: US 2023/0056647 A1
(43) Pub. Date: Feb. 23, 2023

(54) TECHNIQUES FOR TRANSMITTING MULTI-CHANNELS IN SHARED RADIO FREQUENCY SPECTRUM

(71) Applicant: QUALCOMM INCORPORATED, San Diego, CA (US)

(72) Inventors: Xiaoxia ZHANG, San Diego, CA (US); Changlong XU, Beijing (CN); Jing SUN, San Diego, CA (US)

(21) Appl. No.: 17/759,685

(22) PCT Filed: Mar. 16, 2020
(86) PCT No.: PCT/CN2020/079453

§ 371 Date: Jul. 28, 2022

(51) Int. Cl. H04W 74/08; H04W 72/12

(52) U.S. Cl. CPC H04W 74/0808; H04W 72/1242

(57) ABSTRACT

Methods, systems, and devices for multi-channel wireless communications using shared radio frequency spectrum are provided. Prior to multi-channel transmissions, a user equipment (UE) may perform a separate listen before talk (LBT) procedure for each channel. Prior to performing the LBT procedures, the UE may identify a set of channels that are to be used for the multi-channel transmission, where the set of channels may include less channels than are allocated or configured to the UE for a slot. The UE identify the set of channels based on one or more multiplexing and prioritization procedures for uplink communications that are allocated or configured for a slot, and determine the set of uplink channels after performing the multiplexing and prioritization procedures. In some cases, the multiplexing and prioritization procedures may include intra-UE multiplexing and prioritization procedures, inter-UE multiplexing and prioritization procedures, or combinations thereof.

### CROSS REFERENCE

The present application is a 371 national stage filing of International PCT Application No. PCT/CN2020/079453 by ZHANG et al. entitled “TECHNIQUES FOR TRANSMITTING MULTI-CHANNELS IN SHARED RADIO FREQUENCY SPECTRUM,” filed Mar. 16, 2020, which is assigned to the assignee hereof, and which is expressly incorporated by reference in its entirety herein

### FIELD OF TECHNOLOGY

The following relates generally to wireless communications and more specifically to techniques for transmitting multi-channels in shared radio frequency spectrum.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some deployments, UEs and base stations may use one or more portions of a radio frequency spectrum band, which may be referred to as a channel or bandwidth part (BWP), for communications. Further, in some cases, one or more channels may be in a shared radio frequency spectrum band in which various different users may access the radio frequency spectrum band using contention-based access techniques (e.g., using a listen-before-talk (LBT) procedure). In cases where communications use multiple channels of a shared radio frequency spectrum band, each channel may have a separate LBT procedure. Further, in some cases, when the LBT for one channel fails, none of the multiple channels are used for transmissions. Thus, efficient techniques to transmit multi channels in shared radio frequency spectrum would help to enhance system operation and efficiency.

### SUMMARY

The described techniques relate to improved methods, systems, devices, and apparatuses that support techniques for transmitting multi-channels in shared radio frequency spectrum. In various aspects, techniques provide for identification of channels that are to be used for an uplink transmission prior to performing a listen before talk (LBT) procedure for each of the identified channels, where the identified channels may be different than all of the channels that are allocated or configured for an uplink transmission in a slot. In some cases, the identified channels may include less channels than are allocated or configured to a user equipment (UE), and performing the LBT procedure on fewer channels may provide a higher likelihood of a successful LBT procedure and enhance efficiency of wireless communications. In some cases, the UE may perform one or more multiplexing and prioritization procedures for all uplink communications that are allocated or configured for a slot, and determine a set of uplink channels that will be used for an uplink transmission. The set of channels may be identical to or different than the allocated or configured channels, and LBT is performed only on the set of channels. In some cases, the multiplexing and prioritization procedures may include intra-UE multiplexing and prioritization procedures, inter-UE multiplexing and prioritization procedures, or combinations thereof.

A method of wireless communication at a UE is described. The method may include receiving, from a base station, a resource allocation for a first uplink communication in a first slot, where the resource allocation indicates at least a first radio frequency channel in a shared radio frequency spectrum band is allocated for the first uplink communication, identifying a second uplink communication that is scheduled in the first slot for transmission using at least a second radio frequency channel in the shared radio frequency spectrum band, determining a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication, and performing a listen before talk procedure to access the set of radio frequency channels in the shared radio frequency spectrum band.

An apparatus for wireless communication at a UE is described. The apparatus may include a processor, memory coupled with the processor, and instructions stored in the memory. The instructions may be executable by the processor to cause the apparatus to receive, from a base station, a resource allocation for a first uplink communication in a first slot, where the resource allocation indicates at least a first radio frequency channel in a shared radio frequency spectrum band is allocated for the first uplink communication, identify a second uplink communication that is scheduled in the first slot for transmission using at least a second radio frequency channel in the shared radio frequency spectrum band, determine a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication, and perform a listen before talk procedure to access the set of radio frequency channels in the shared radio frequency spectrum band.

Another apparatus for wireless communication at a UE is described. The apparatus may include means for receiving, from a base station, a resource allocation for a first uplink communication in a first slot, where the resource allocation indicates at least a first radio frequency channel in a shared radio frequency spectrum band is allocated for the first uplink communication, identifying a second uplink communication that is scheduled in the first slot for transmission using at least a second radio frequency channel in the shared radio frequency spectrum band, determining a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication, and performing a listen before talk procedure to access the set of radio frequency channels in the shared radio frequency spectrum band.

A non-transitory computer-readable medium storing code for wireless communication at a UE is described. The code may include instructions executable by a processor to receive, from a base station, a resource allocation for a first uplink communication in a first slot, where the resource allocation indicates at least a first radio frequency channel in a shared radio frequency spectrum band is allocated for the first uplink communication, identify a second uplink communication that is scheduled in the first slot for transmission using at least a second radio frequency channel in the shared radio frequency spectrum band, determine a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication, and perform a listen before talk procedure to access the set of radio frequency channels in the shared radio frequency spectrum band.

Some examples of the method, apparatuses, and non-transitory computer-readable medium described herein may further include operations, features, means, or instructions for determining, based on the listen before talk procedure, that each frequency channel of the set of radio frequency channels in the shared radio frequency spectrum band may be available for transmissions in the first slot, and transmitting the uplink transmission in the first slot using the set of radio frequency channels. Some examples of the method, apparatuses, and non-transitory computer-readable medium described herein may further include operations, features, means, or instructions for determining, based on the listen before talk procedure, that one or more frequency channels of the set of radio frequency channels in the shared radio frequency spectrum band are unavailable for transmissions in the first slot, and deferring the uplink transmission using the set of radio frequency channels.

In some examples of the method, apparatuses, and non-transitory computer-readable medium described herein, the set of radio frequency channels may be less than all of the radio frequency channels associated with the first uplink communication and the second uplink communication. In some examples of the method, apparatuses, and non-transitory computer-readable medium described herein, the set of radio frequency channels includes all of the radio frequency channels associated with the first uplink communication and all of the radio frequency channels associated with the second uplink communication. In some examples of the method, apparatuses, and non-transitory computer-readable medium described herein, the determining may be based on an intra-UE multiplexing and prioritization procedure, an inter-UE multiplexing and prioritization procedure, or combinations thereof. In some examples of the method, apparatuses, and non-transitory computer-readable medium described herein, the first uplink communication may be an uplink shared channel communication and the second uplink communication may be an uplink control channel communication.

Some examples of the method, apparatuses, and non-transitory computer-readable medium described herein may further include operations, features, means, or instructions for multiplexing the uplink control channel communication with the uplink shared channel communication according to the intra-UE multiplexing and prioritization procedure, and where the set of radio frequency channels include at least the first radio frequency channel allocated for the first uplink communication, and excludes at least the second radio frequency channel. Some examples of the method, apparatuses, and non-transitory computer-readable medium described herein may further include operations, features, means, or instructions for prioritizing the uplink control channel communication over the uplink shared channel communication according to the intra-UE multiplexing and prioritization procedure based on the uplink control channel communication being associated with a higher priority communication than the uplink shared channel communication, and where the set of radio frequency channels include at least the second radio frequency channel, and excludes at least the first radio frequency channel allocated for the first uplink communication.

Some examples of the method, apparatuses, and non-transitory computer-readable medium described herein may further include operations, features, means, or instructions for receiving an indication that a different UE is scheduled with resources in the first slot using at least the first radio frequency channel allocated for the first uplink communication, determining that the different UE has a higher priority for transmission on the first radio frequency channel than the first uplink communication according to the inter-UE multiplexing and prioritization procedure, deferring the first uplink communication based on the determining that the different UE has the higher priority for transmission on the first radio frequency channel in the first slot, and where the set of radio frequency channels for the listen before talk procedure include at least the second radio frequency channel, and excludes at least the first radio frequency channel allocated for the first uplink communication.

In some examples of the method, apparatuses, and non-transitory computer-readable medium described herein, the first uplink communication is associated with a first listen before talk category and the second uplink communication is associated with a second listen before talk category that has a higher priority than the first listen before talk category. Some examples of the method, apparatuses, and non-transitory computer-readable medium described herein may further include operations, features, means, or instructions for prioritizing the second uplink communication over the first uplink communication according to an intra-UE prioritization procedure based on the second uplink communication being associated with the higher priority listen before talk category, and where the set of radio frequency channels includes the second radio frequency channel and excludes at least the first radio frequency channel allocated for the first uplink communication. In some examples of the method, apparatuses, and non-transitory computer-readable medium described herein, the second listen before talk category corresponds to a type 2 channel access procedure within a channel occupancy time (COT) acquired by the base station, and the first listen before talk category corresponds to a type 1 channel access procedure outside of a COT acquired by the base station or associated with a random access transmission.

### BRIEF DESCRIPTION OF THE DRAWINGS

FIG. 1 illustrates an example of a system for wireless communications that supports techniques for transmitting multi-channels in shared radio frequency spectrum in accordance with aspects of the present disclosure.

FIG. 2 illustrates an example of a portion of a wireless communications system that supports techniques for transmitting multi-channels in shared radio frequency spectrum in accordance with aspects of the present disclosure.

FIG. 3 illustrates an example of a channel prioritization that supports techniques for transmitting multi-channels in shared radio frequency spectrum in accordance with aspects of the present disclosure.

FIG. 4 illustrates an example of a channel prioritization that supports techniques for transmitting multi-channels in shared radio frequency spectrum in accordance with aspects of the present disclosure.

FIG. 5 illustrates an example of a channel prioritization that supports techniques for transmitting multi-channels in shared radio frequency spectrum in accordance with aspects of the present disclosure.

FIG. 6 illustrates an example of a channel prioritization that supports techniques for transmitting multi-channels in shared radio frequency spectrum in accordance with aspects of the present disclosure.

FIG. 7 illustrates an example of a process flow that supports techniques for transmitting multi-channels in shared radio frequency spectrum in accordance with aspects of the present disclosure.

FIGS. 8 and 9 show block diagrams of devices that support techniques for transmitting multi-channels in shared radio frequency spectrum in accordance with aspects of the present disclosure.

FIG. 10 shows a block diagram of a communications manager that supports techniques for transmitting multi-channels in shared radio frequency spectrum in accordance with aspects of the present disclosure.

FIG. 11 shows a diagram of a system including a device that supports techniques for transmitting multi-channels in shared radio frequency spectrum in accordance with aspects of the present disclosure.

FIGS. 12 through 15 show flowcharts illustrating methods that support techniques for transmitting multi-channels in shared radio frequency spectrum in accordance with aspects of the present disclosure.

### DETAILED DESCRIPTION

Various aspects of the present disclosure provide techniques for channel selection for listen before talk (LBT) procedures in a shared radio frequency spectrum band. In some aspects, a base station and a user equipment (UE) may use multi-channel transmissions in which two or more radio frequency channels may be used for uplink communications from the UE to the base station, for downlink communications from the base station to the UE, or both. Prior to transmitting using multiple channels, an LBT procedure for each channel is performed to confirm that the particular channel is available for transmission. In the event that all of the channels pass the LBT procedure, the multi-channel transmission may proceed, and in the event that one or more channels fail the LBT procedure, the multi-channel transmission may be deferred until a later slot. In accordance with various aspects, prior to a multi-channel uplink transmission in a slot, a UE may determine a set of channels to be used for the uplink transmission, and perform LBT only on the channels of the set of channels.

In some cases, the set of channels may be less than all channels associated with uplink transmissions in the slot. For example, the UE may receive a resource allocation for a physical uplink shared channel (PUSCH) transmission using two channels in a slot, and the UE may further be indicated to transmit a physical uplink control channel (PUCCH) communication in the same slot using a third channel. However, an intra-UE multiplexing and prioritization procedure may provide that in the event of overlapping PUSCH and PUCCH communication, the PUCCH communications may be multiplexed with the PUSCH communication, and the multiplexed communication may be transmitted using one or more channels associated with the PUSCH resource allocation. Thus, in such cases, the third channel that was configured for PUCCH transmission in the slot is unused. In accordance with techniques as discussed herein, the UE may avoid performing LBT on such unused channels, which may enhance the likelihood of successful LBT and help enhance communications efficiency.

In some cases, the UE may perform intra-UE multiplexing and prioritization procedures based on types of data to be transmitted, channel access procedures associated with different communications (e.g., a Type 1 channel access procedure or a type 2 channel access procedure, which have different LBT categories), data priorities associated with the different communications (e.g., ultra-reliable low latency communications (URLLC) may have priority over enhanced mobile broadband (eMBB) communications), or any combinations thereof. Additionally or alternatively, a first UE may perform inter-UE multiplexing and prioritization procedures, in which a different UE may be identified that has data for transmission using one or more channels in the slot. In such cases, if the data of the different UE has a higher priority (e.g., URLLC data versus eMBB data), the lower priority communication in the slot may be dropped by the first UE. If the first UE has one or more uplink communications that have non-overlapping channels with the higher priority data of the different UE, the first UE may then perform LBT on the non-overlapping channels.

Such techniques may provide for efficient performance of LBT procedures in shared radio frequency spectrum. For example, techniques as discussed herein may be used to advantageously perform LBT only on channels that are to be used for an uplink transmission, rather than all channels having an associated configuration or allocation within a slot. Thus may result in a higher likelihood of a successful LBT procedure, and therefore reduced instances in which an uplink transmission may need to be deferred to a later slot. Accordingly, techniques according to various aspects may allow for enhanced efficiency and reliability in the use of shared radio frequency spectrum bands, which may also reduce communications latency.

Aspects of the disclosure are initially described in the context of wireless communications systems. Various examples of multi-channel transmissions and techniques for channel determination are then described. Aspects of the disclosure are further illustrated by and described with reference to apparatus diagrams, system diagrams, and flowcharts that relate to techniques for transmitting multi-channels in shared radio frequency spectrum.

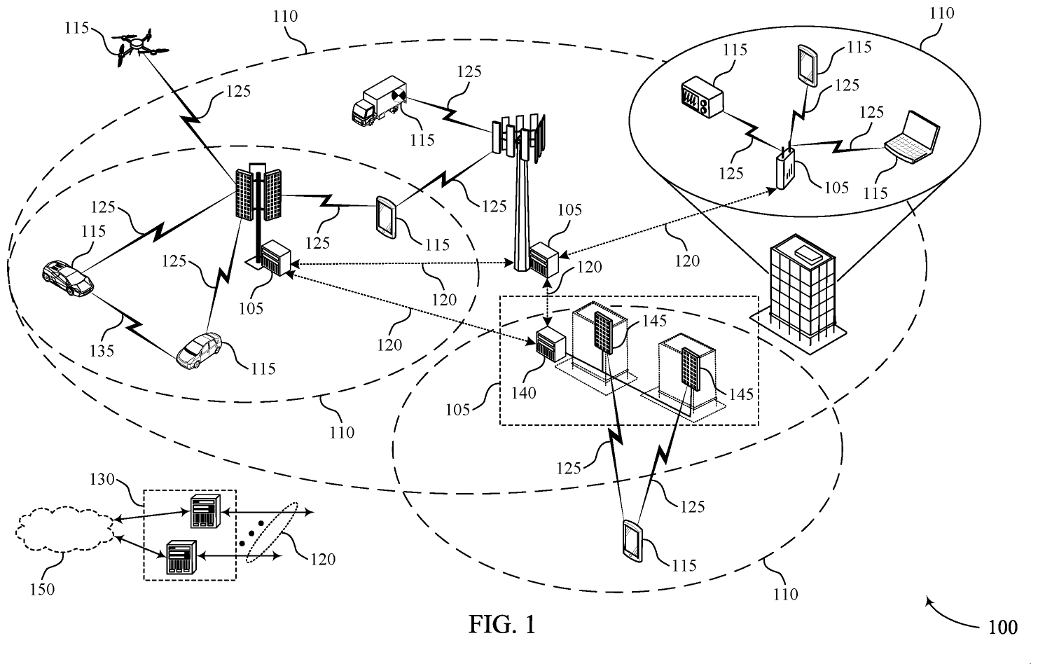

FIG. 1 illustrates an example of a wireless communications system 100 that supports techniques for transmitting multi-channels in shared radio frequency spectrum in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, UEs 115 and base station 105 may operate using shared radio frequency spectrum and use multi-channel transmissions. Prior to transmitting the multi-channel transmissions, UEs 115 and base station 105 may perform a separate LBT procedure for each channel, and may initiate a transmission according to an all-or-nothing rule in which all of the channels are to pass LBT prior to a transmission. Thus, if one or more of the channels fails the LBT procedure, the multi-channel transmission is deferred to a later slot (e.g., based on a contention window backoff technique associated with a failed LBT). In some cases, for an uplink multi-channel transmission, a UE 115 may determine a set of channels that are to be used for an uplink transmission, where the set of channels may include less channels than are allocated or configured to the UE 115 for a slot. In some cases, the UE 115 may perform one or more multiplexing and prioritization procedures for all uplink communications that are allocated or configured for a slot, and determine the set of uplink channels after performing the multiplexing and prioritization procedures, such that the set of channels may be identical to or different than the allocated or configured channels for the slot. In some cases, the multiplexing and prioritization procedures may include intra-UE multiplexing and prioritization procedures, inter-UE multiplexing and prioritization procedures, or combinations thereof.

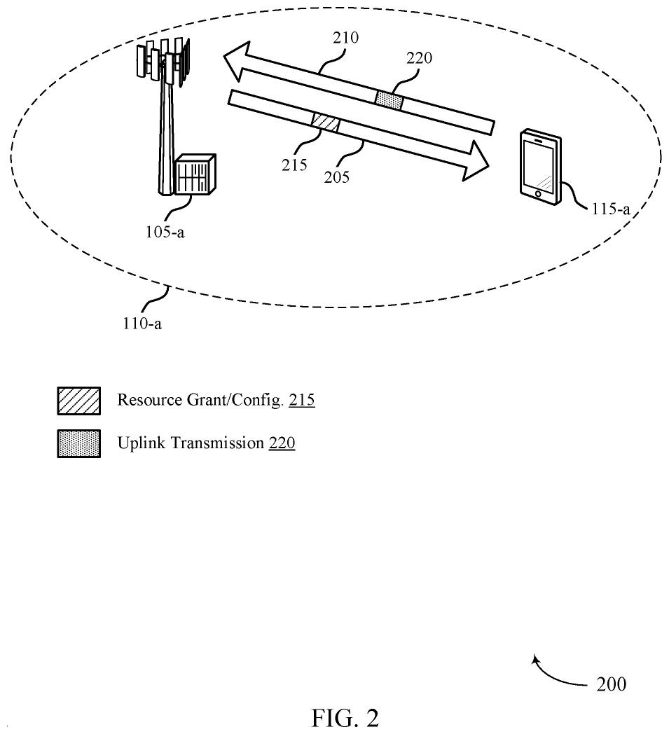

FIG. 2 illustrates an example of a wireless communications system 200 that supports techniques for transmitting multi-channels in shared radio frequency spectrum in accordance with aspects of the present disclosure. In some examples, wireless communications system 200 may implement aspects of wireless communications system 100. Wireless communications system 200 may include base station 105-a and UE 115-a, which may be respective examples of a base station 105 and a UE 115 as described herein.

UE 115-a and base station 105-a may communicate via downlink carrier 205 and uplink carrier 210. In some cases, carriers 205 and 210 may be the same carrier. In some cases, carriers 205 and 210 may span multiple channels for communications (e.g., multiple 20 MHz channels). For example, in some cases communications using shared radio frequency spectrum may support wideband operation in which an uplink transmission 220 from the UE 115-a to the base station 105-a may be scheduled to span multiple channels. Due to the wideband operation, it is possible to have one uplink transmission (e.g., a PUSCH transmission) scheduled on one set of channels while another uplink transmission (e.g., a PUCCH transmission) is scheduled on another set of channels. In the example of FIG. 2, the base station 105-a may transmit a resource grant or configuration 215 to the UE 115-a that results in a particular uplink slot having two or more communications that are scheduled. Further, in cases where the different communications are associated with different channels, the UE 115-a may have a number of channels associated with each of the scheduled communications.

In some cases, prior to transmitting the multi-channel uplink transmission 220, the UE 115-a may perform a separate LBT procedure for each channel, and may initiate a uplink transmission 220 according to an all-or-nothing rule in which all of the channels are to pass LBT prior to transmitting. Thus, if one or more of the channels fails the LBT procedure, the uplink transmission 220 is deferred to a later slot (e.g., based on a contention window backoff technique associated with a failed LBT). In some cases, the UE 115-a may determine a set of channels that are to be used for the uplink transmission 220, where the set of channels may include less channels than are allocated or configured to the UE 115-a for a slot. For example, the UE 115-a may receive an allocation to transmit PUSCH using a first channel and a second channel in a slot, and may also be configured to report HARQ ACK/NACK feedback in a PUCCH communication in the same slot using a third channel.

In some cases, the UE 115-a may perform one or more multiplexing and prioritization procedures for all uplink communications that are allocated or configured for the slot, and determine the set of uplink channels after performing the multiplexing and prioritization procedures, such that the set of channels may be identical to or different than the allocated or configured channels for the slot. For example, in cases where control information communications for HARQ-ACK feedback and PUSCH communications overlap in a slot, the UE 115-a may multiplex the control information with the PUSCH communications for transmission on the channels allocated for PUSCH. Thus, in such an example, the set of channels may correspond to the allocated channels for PUSCH and may not include the one or more channels associated with the control information transmission. In some cases, the multiplexing and prioritization procedures may include intra-UE multiplexing and prioritization procedures, inter-UE multiplexing and prioritization procedures, or combinations thereof. Following the determination of the set of channels, the UE 115-a may perform LBT on each channel of the set of channels prior to transmitting uplink transmission 220.

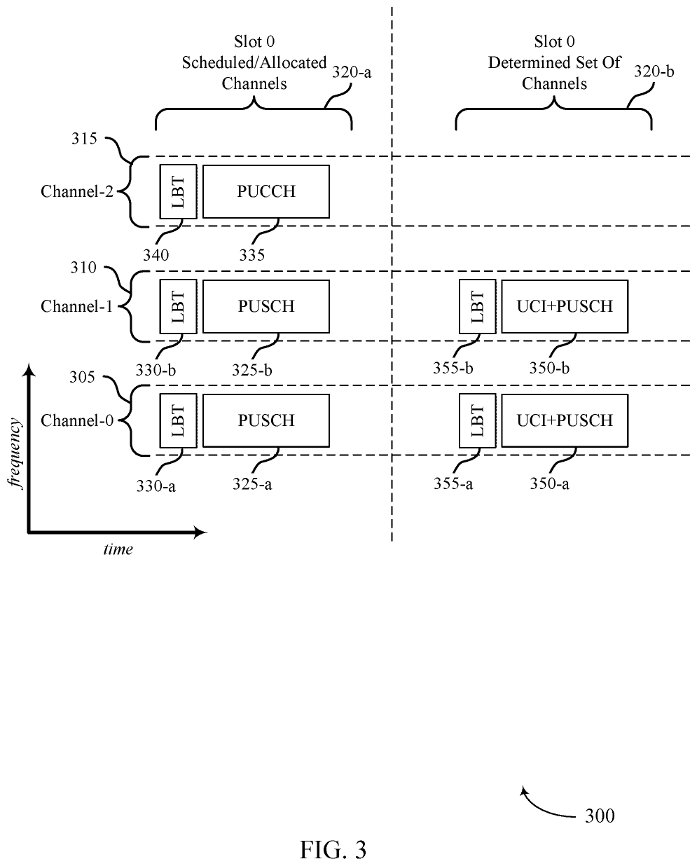

FIG. 3 illustrates an example of a channel prioritization 300 that supports techniques for transmitting multi-channels in shared radio frequency spectrum in accordance with aspects of the present disclosure. In some examples, channel prioritization 300 may implement aspects of wireless communications system 100 or 200. In this example, a first channel 305, a second channel 310, and a third channel 315 may be associated with uplink communications from a UE (e.g., a UE 115 of FIG. 1 or 2) during a slot 320.

The UE, in some examples, may receive an uplink grant in which a PUSCH communication 325 is allocated in the slot 320 for transmission via the first channel 305 and the second channel 310. Further, the UE may be indicated for PUCCH communication 335 during the slot 320 via the third channel 315. Thus, in this example, scheduled or allocated channels for the slot 320-a include a first portion of PUSCH communications 325-a in the first channel 305, a second portion of PUSCH communications 325-b in the second channel 310, and PUCCH communication 335 in the third channel 315. As discussed herein, each channel 305 through 315 of a multi-channel transmission may have an associated LBT, which in this example include a first LBT 330-a for the first channel 305, a second LBT 330-b for the second channel 310, and a third LBT 340 for the third channel 315.

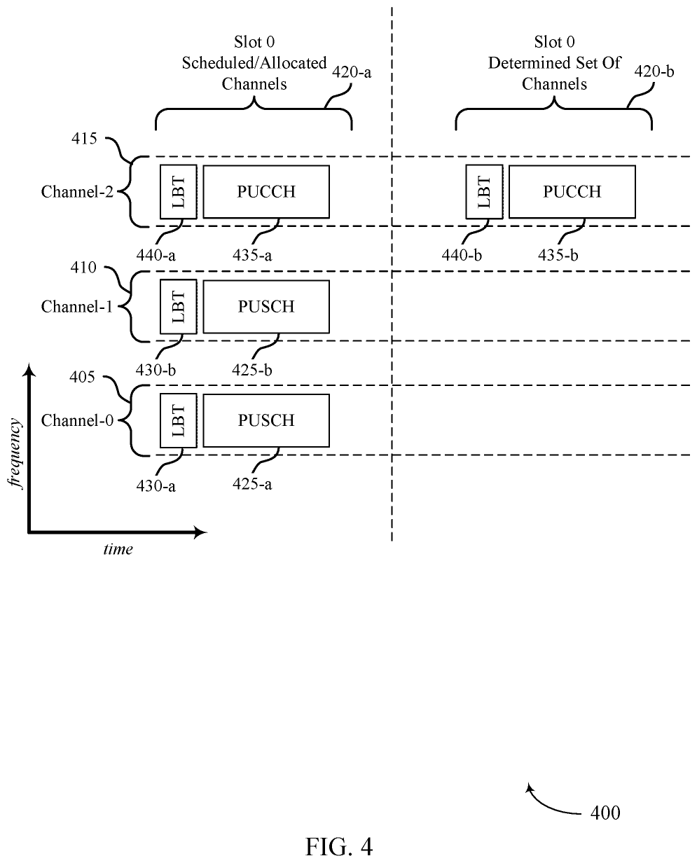

In some cases, the UE may perform one or more multiplexing and prioritization procedures and identify a determined set of channels for the slot 320-b. For example, an uplink control information (UCI) multiplexing rule may be applied to transmissions of the slot 320. Such a UCI multiplexing rule, in cases where both PDSCH communications that are associated with the PUCCH communication 335 and PUSCH communications 325 have a same priority, may provide that the PUCCH communication 335 are piggybacked with PUSCH communications 325 and transmitted via the first channel 305 and the second channel 310. Thus, in this example, the determined set of channels for the slot 320-b include multiplexed UCI and PUSCH 350, for transmission via the first channel 305 and second channel 310. As a result, even though the UE is scheduled on the first channel 305 through the third channel 315, after intra-UE UCI multiplexing, UE can only potentially transmit on the first channel 305 and the second channel 310. In accordance with techniques discussed herein, the UE may then perform a first LBT 355-a for the first channel 305 and a second LBT 355-b for the second channel. A LBT associated with the third channel 315 is not performed, as the PUCCH 335 is not actually transmitted on the third channel 315, and thus resources associated with performing a LBT on the third channel 315 are saved, and the likelihood of a successful all-or-nothing LBT is increased due to performing LBT on fewer channels. In other examples, such as illustrated in FIG. 4, an inter-UE multiplexing and priority procedure may be based on a priority associated with different uplink communications.

FIG. 4 illustrates an example of a channel prioritization 400 that supports techniques for transmitting multi-channels in shared radio frequency spectrum in accordance with aspects of the present disclosure. In some examples, channel prioritization 400 may implement aspects of wireless communications system 100 or 200. In this example, a first channel 405, a second channel 410, and a third channel 415 may be associated with uplink communications from a UE (e.g., a UE 115 of FIG. 1 or 2) during a slot 420.

The UE, in this example, may receive an uplink grant in which a PUSCH communication 425 is allocated in the slot 420 for transmission via the first channel 405 and the second channel 410. Further, the UE may be indicated for PUCCH communication 435-a during the slot 420 via the third channel 415. Thus, in this example, similarly as with the example of FIG. 3, scheduled or allocated channels for the slot 420-a include a first portion of PUSCH communications 425-a in the first channel 405, a second portion of PUSCH communications 425-b in the second channel 410, and PUCCH communication 435 in the third channel 415. As discussed herein, each channel 405 through 415 of a multi-channel transmission may have an associated LBT, which in this example include a first LBT 430-a for the first channel 405, a second LBT 430-b for the second channel 410, and a third LBT 440-a for the third channel 415.

In this case, the communications associated with the PUCCH communication 435-a (e.g., PDSCH communications for which the UCI includes HARQ ACK/NACK information) may have a higher priority than the PUSCH communications 425. In such a case, the UCI multiplexing and prioritization rule may provide that the lower priority PUSCH communications 425 are dropped, and the higher priority PUCCH communication 435-b is transmitted, and thus the determined set of channels for the slot 420-b may include only the third channel 415 associated with the PUCCH communication 435-b. As a result, even though the UE is scheduled on the first channel 405 through the third channel 415, after intra-UE UCI multiplexing, UE can only potentially transmit on the third channel 415. In accordance with techniques discussed herein, the UE may then perform a LBT 440-b for the third channel 415 prior to transmitting the PUCCH communication 435-b. LBTs associated with the first channel 405 and the second channel 410 are not performed, as the PUSCH communications 425 are not actually transmitted, and the likelihood of a successful all-or-nothing LBT is increased due to performing LBT on fewer channels. In other examples, such as illustrated in FIG. 4, an inter-UE multiplexing and priority procedure may be based on a priority associated with different uplink communications.

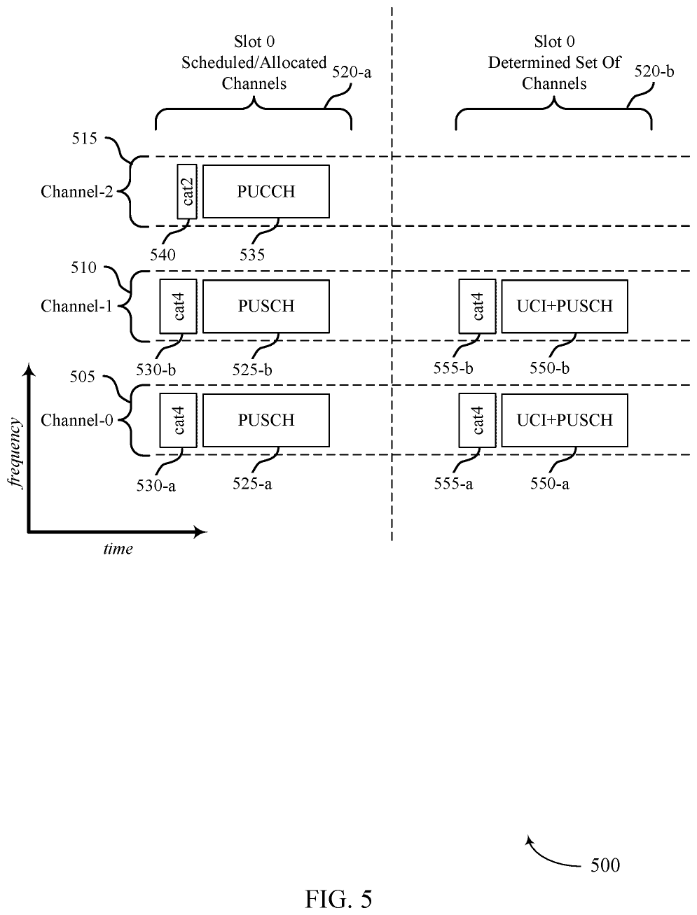

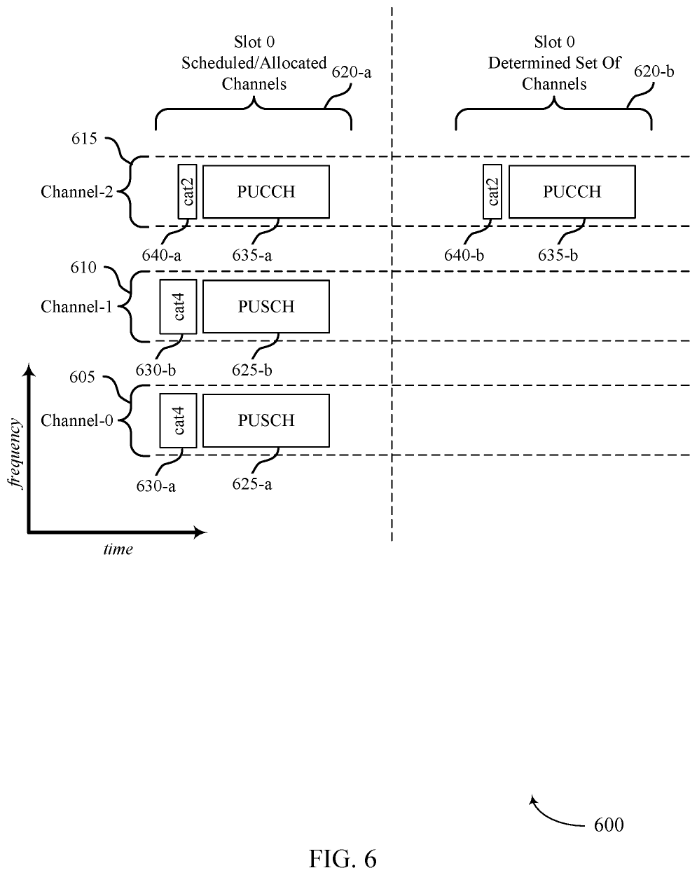

While the examples of FIGS. 3 and 4 discuss UCI multiplexing and prioritization relative to PUSCH communications, such techniques may be used with any number of different multiplexing or prioritization that may be applied to uplink communications from a UE, or may be applied to inter-UE communications, such as when a different UE has higher priority communications that may preempt another UEs lower priority communication. Thus, with intra-UE or inter-UE multiplexing and prioritization, the actual channel set for a potential transmission in a slot can be different from the channel set listed in the uplink scheduling at the UE. As discussed herein, various aspects of the present disclosure provide techniques in which the UE performs uplink multi-channel channel access procedures (e.g., LBT procedures) based on the grants after the intra or inter-UE prioritization. Further, the all-or-nothing transmission due to LBT failure is applied to the scheduled channel after the intra-UE or inter-UE prioritization. In other cases, however, a UE may perform uplink multi-channel channel access procedures based on the grants before the intra-UE or inter-UE prioritization, with the all or nothing transmission due to LBT failure applied to the scheduled channels before the intra-UE or inter-UE prioritization. In some cases, the UE may receive configuration information from a base station (e.g., via RRC signaling) that indicates whether to perform LBT before or after intra-UE or inter-UE multiplexing and prioritization procedures. In some cases, UE multiplexing and prioritization procedures may, additionally or alternatively, be based on a type of channel access associated with uplink communications. FIGS. 5 and 6 illustrate two examples of channel determination based on channel access techniques.

FIG. 5 illustrates an example of a channel prioritization 500 that supports techniques for transmitting multi-channels in shared radio frequency spectrum in accordance with aspects of the present disclosure. In some examples, channel prioritization 500 may implement aspects of wireless communications system 100 or 200. In this example, a first channel 505, a second channel 510, and a third channel 515 may be associated with uplink communications from a UE (e.g., a UE 115 of FIG. 1 or 2) during a slot 520.

The UE, in this example, may receive an uplink grant in which a PUSCH communication 525 is allocated in the slot 520 for transmission via the first channel 505 and the second channel 510. Further, the UE may be indicated for PUCCH communication 535 during the slot 520 via the third channel 515. Thus, in this example, scheduled or allocated channels for the slot 520-a include a first portion of PUSCH communications 525-a in the first channel 505, a second portion of PUSCH communications 525-b in the second channel 510, and PUCCH communication 535 in the third channel 515. Further, in this example, the first channel 505 and the second channel 510 may be associated with a first type of channel access (e.g., Type 1 channel access) that may have a first LBT category (e.g., a category 4 LBT 530 having a first contention window duration). The third channel 515 may have a second type of channel access (e.g., Type 2 channel access) that may have a second LBT category such as a category 2 LBT 540 having a second contention window duration (or a one-shot LBT) that is shorter than the first contention window duration based on the PUCCH communication 535 being within a channel occupancy time (COT) acquired by the base station. In this example, the PUSCH communication 525 may have a same priority as downlink transmissions associated with the PUCCH communication 535, and thus the UCI multiplexing rule may provide that UCI is piggybacked with the PUSCH communication 525.

In some cases, the UE may perform intra-UE multiplexing first and decide on the LBT type based on the set of channels after intra-UE multiplexing. In this case, the UE will try to transmit UCI and PUSCH 550 with category 4 LBT 555 via the first channel 505 and the second channel 510. In other cases, such as illustrated in FIG. 6, the UE may prioritize uplink transmissions within a slot based on the LBT type.

FIG. 6 illustrates an example of a channel prioritization 600 that supports techniques for transmitting multi-channels in shared radio frequency spectrum in accordance with aspects of the present disclosure. In some examples, channel prioritization 600 may implement aspects of wireless communications system 100 or 200. In this example, a first channel 605, a second channel 610, and a third channel 615 may be associated with uplink communications from a UE (e.g., a UE 115 of FIG. 1 or 2) during a slot 620.

The UE, in this example, again may receive an uplink grant in which a PUSCH communication 625 is allocated in the slot 620 for transmission via the first channel 605 and the second channel 610. Further, the UE may be configured for PUCCH communication 635-a during the slot 620 via the third channel 615. Thus, in this example, scheduled or allocated channels for the slot 620-a include a first portion of PUSCH communications 625-a in the first channel 605, a second portion of PUSCH communications 625-b in the second channel 610, and PUCCH communication 635 in the third channel 615.

Further, in this example, the first channel 605 and the second channel 610 may be associated with a first type of channel access (e.g., Type 1 channel access) that may have a first LBT category (e.g., a category 4 LBT 630 having a first contention window duration).

The third channel 615 may have a second type of channel access (e.g., Type 2 channel access) that may have a second LBT category such as a category 2 LBT 640 having a second contention window duration (or a one-shot LBT) that is shorter than the first contention window duration based on the PUCCH communication 635 being within a COT acquired by the base station. In this example, the PUSCH communication 625 may have a same priority as downlink transmissions associated with the PUCCH communication 635, however, the UCI multiplexing rule may provide that an uplink communication may be prioritized based on LBT type. Thus, in this example, the category 2 LBT 640 may be prioritized over category 4 LBT 630, and thus the determined set of channels for the slot 620-b may include the PUCCH communication 635-b, with the PUSCH communications 625 dropped. The UE may then perform the category 2 LBT 640-b prior to transmission the PUCCH communication 635-b.

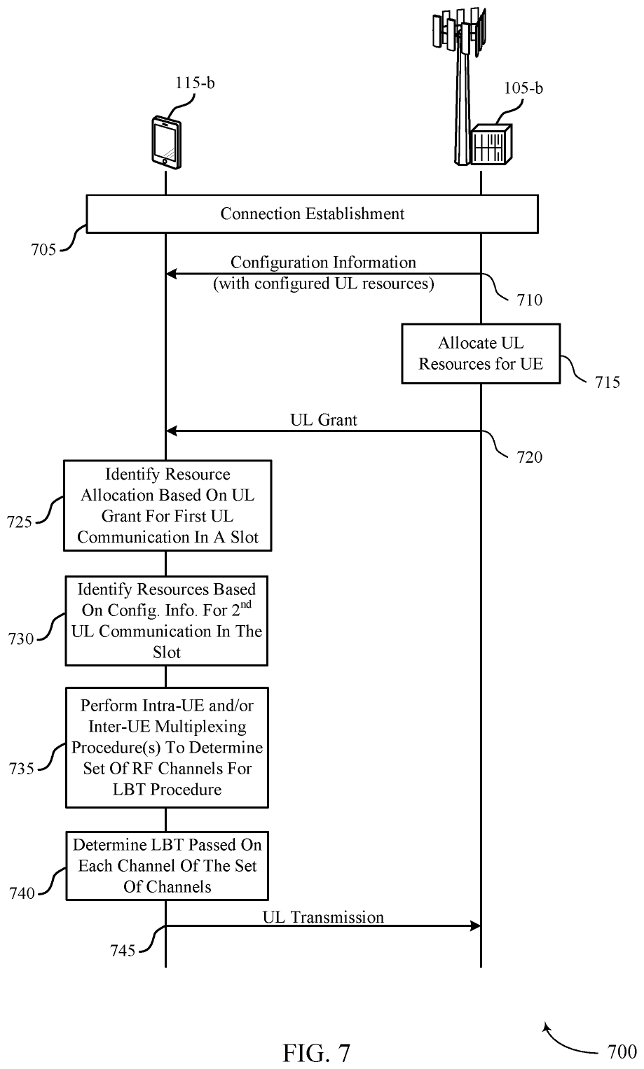

FIG. 7 illustrates an example of a process flow 700 that supports techniques for transmitting multi-channels in shared radio frequency spectrum in accordance with aspects of the present disclosure. In some examples, process flow 700 may implement aspects of wireless communications system 100 or 200. Process flow 700 may be implemented by UE 115-b and base station 105-b, as described herein. Alternative examples of the following may be implemented, where some steps are performed in a different order than described or are not performed at all. In some cases, steps may include additional features not mentioned below, or further steps may be added.

At 705, the base station 105-b and UE 115-b may perform a connection establishment procedure (e.g., a RRC connection establishment or reestablishment procedure) in which communications via a shared radio frequency spectrum band may be configured.

At 710, the base station 105-b may transmit configuration information to the UE 115-b. Such configuration may, in some cases, configure the UE 115-b to transmit UCI (e.g., HARQ-ACK feedback) in certain uplink resources following one or more downlink shared channel transmissions. In some cases, the configuration information may include a configuration or activation for semi-persistent uplink resources for uplink communications from the UE 115-b.

At 715, the base station 105-b may allocate uplink resources for the UE 115-b. At 720, the uplink resources may be provided to the UE 115-b in a downlink transmission (e.g., in downlink control information (DCI)) that provides an uplink grant. In some cases, the uplink grant may provide an allocation of uplink resources for PUSCH communications in a slot, where the slot may also include resources that are configured by the configuration information.

At 725, the UE 115-b may identify a resource allocation based on the uplink grant for a first uplink communication in a slot. The resource allocation may be indicated in the DCI, and may provide uplink resources in multiple channels within the slot. In some cases, the first uplink communication may be associated with a first category of LBT procedure.

At 730, the UE 115-b may identify uplink resources for a second uplink communication in the slot based on the configuration information. In some cases, the second uplink communication may include uplink control information, and associated resources may include one or more channels in the slot that are different than the one or more channels associated with the first uplink communication. In some cases, the uplink control information may be associated with a second category of LBT procedure (e.g., based on being within a COT obtained by the base station 105-b.

At 735, the UE 115-b may perform one or more intra-UE and/or inter-UE multiplexing and prioritization procedures to determine a set of channels that are to be used for an uplink transmission to the base station 105-b. The multiplexing and prioritization procedure(s) may be performed as discussed herein, based on the type of data to be transmitted, priorities associated with the different uplink communications, channel access category types or LBT categories for the uplink communications, or any combinations thereof. Based on the determined set of channels, the UE 115-a may perform one or more LBT procedures for each channel in the set of channels.

At 740, the UE 115-b may determine whether LBT passed on each channel of the set of channels, in accordance with an all-or-nothing rule for multi-channel transmissions. At 745, based on determining that the LBT for each channel passed, the UE 115-b may transmit the uplink transmission to the base station 105-b using the determined set of channels.

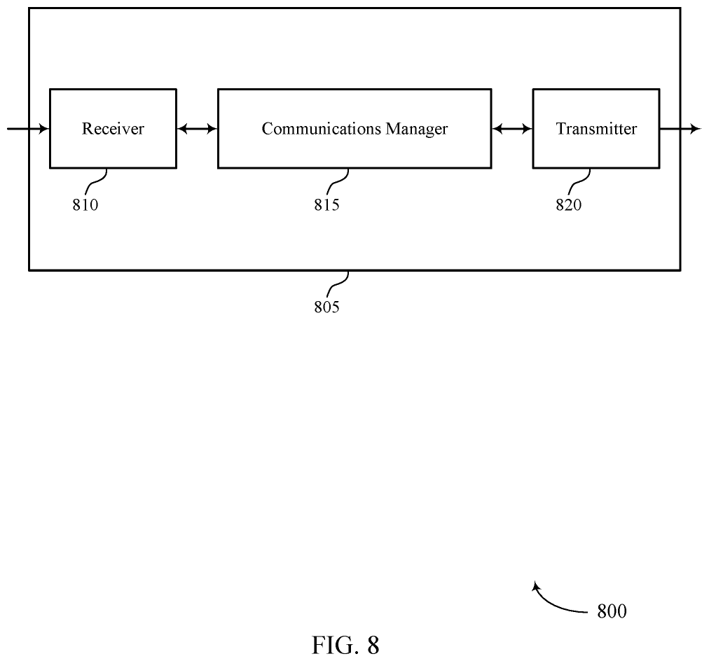

FIG. 8 shows a block diagram 800 of a device 805 that supports techniques for transmitting multi-channels in shared radio frequency spectrum in accordance with aspects of the present disclosure. The device 805 may be an example of aspects of a UE 115 as described herein. The device 805 may include a receiver 810, a communications manager 815, and a transmitter 820. The device 805 may also include a processor. Each of these components may be in communication with one another (e.g., via one or more buses).

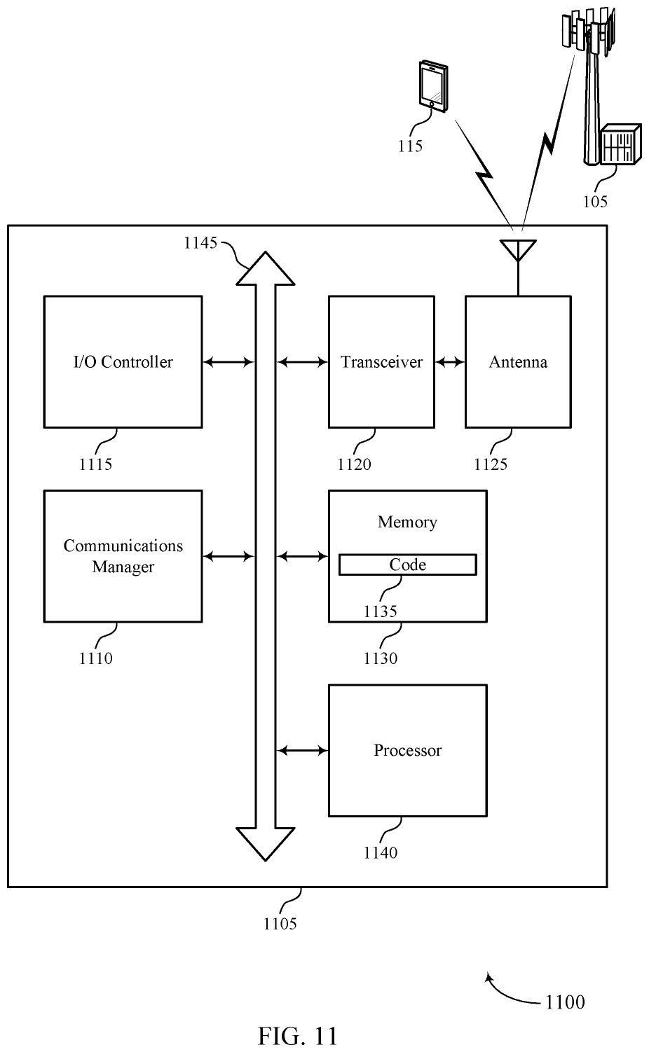

The receiver 810 may receive information such as packets, user data, or control information associated with various information channels (e.g., control channels, data channels, and information related to techniques for transmitting multi-channels in shared radio frequency spectrum, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may receive, from a base station, a resource allocation for a first uplink communication in a first slot, where the resource allocation indicates at least a first radio frequency channel in a shared radio frequency spectrum band is allocated for the first uplink communication, identify a second uplink communication that is scheduled in the first slot for transmission using at least a second radio frequency channel in the shared radio frequency spectrum band, determine a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication, and perform a listen before talk procedure to access the set of radio frequency channels in the shared radio frequency spectrum band. The communications manager 815 may be an example of aspects of the communications manager 1110 described herein.

The communications manager 815 may as described herein be implemented to realize one or more potential advantages. One implementation may allow the device 805 to perform LBT on a reduced number of channels that are to actually be used for an uplink transmission, which may allow for enhanced likelihood of successful LBT. Further, implementations may allow the device 805 to reduce the latency of communications, and increase signaling reliability, throughput, and user experience, while reducing power consumption, among other advantages.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

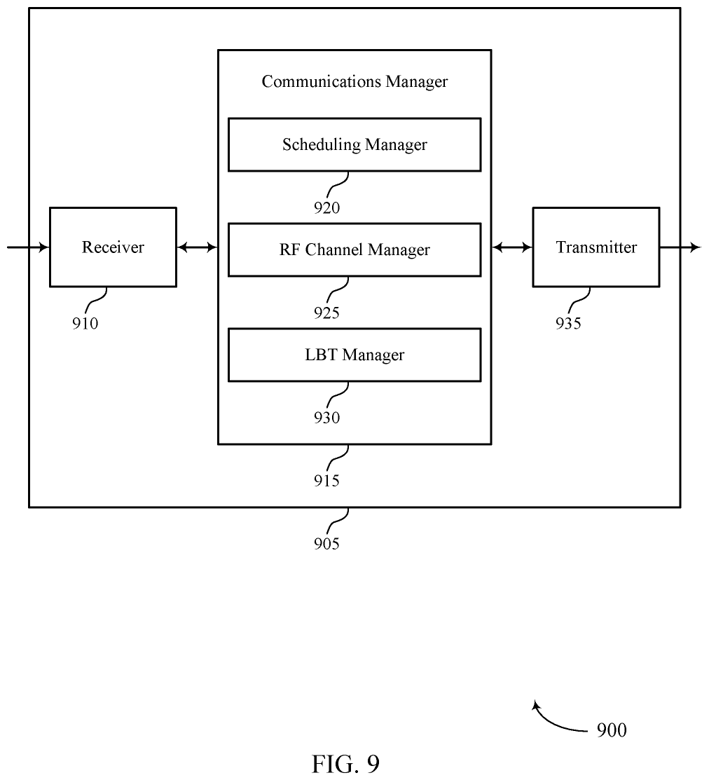

FIG. 9 shows a block diagram 900 of a device 905 that supports techniques for transmitting multi-channels in shared radio frequency spectrum in accordance with aspects of the present disclosure. The device 905 may be an example of aspects of a device 805, or a UE 115 as described herein. The device 905 may include a receiver 910, a communications manager 915, and a transmitter 935. The device 905 may also include a processor. Each of these components may be in communication with one another (e.g., via one or more buses).

The receiver 910 may receive information such as packets, user data, or control information associated with various information channels (e.g., control channels, data channels, and information related to techniques for transmitting multi-channels in shared radio frequency spectrum, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a scheduling manager 920, a RF channel manager 925, and a LBT manager 930. The communications manager 915 may be an example of aspects of the communications manager 1110 described herein.

The scheduling manager 920 may receive, from a base station, a resource allocation for a first uplink communication in a first slot, where the resource allocation indicates at least a first radio frequency channel in a shared radio frequency spectrum band is allocated for the first uplink communication and identify a second uplink communication that is scheduled in the first slot for transmission using at least a second radio frequency channel in the shared radio frequency spectrum band.

The RF channel manager 925 may determine a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication.

The LBT manager 930 may perform a listen before talk procedure to access the set of radio frequency channels in the shared radio frequency spectrum band.

The transmitter 935 may transmit signals generated by other components of the device 905. In some examples, the transmitter 935 may be collocated with a receiver 910 in a transceiver module. For example, the transmitter 935 may be an example of aspects of the transceiver 1120 described with reference to FIG. 11. The transmitter 935 may utilize a single antenna or a set of antennas.

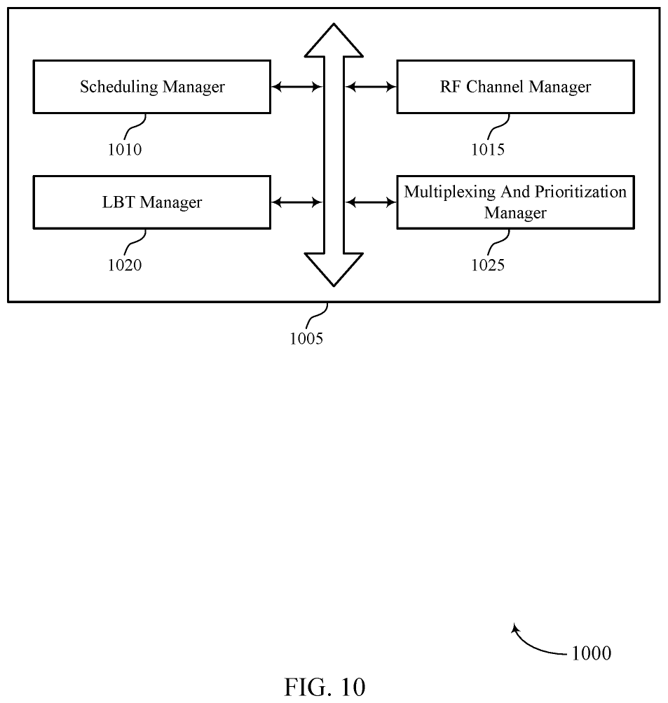

FIG. 10 shows a block diagram 1000 of a communications manager 1005 that supports techniques for transmitting multi-channels in shared radio frequency spectrum in accordance with aspects of the present disclosure. The communications manager 1005 may be an example of aspects of a communications manager 815, a communications manager 915, or a communications manager 1110 described herein. The communications manager 1005 may include a scheduling manager 1010, a RF channel manager 1015, a LBT manager 1020, and a multiplexing and prioritization manager 1025. Each of these modules may communicate, directly or indirectly, with one another (e.g., via one or more buses).

The scheduling manager 1010 may receive, from a base station, a resource allocation for a first uplink communication in a first slot, where the resource allocation indicates at least a first radio frequency channel in a shared radio frequency spectrum band is allocated for the first uplink communication. In some examples, the scheduling manager 1010 may identify a second uplink communication that is scheduled in the first slot for transmission using at least a second radio frequency channel in the shared radio frequency spectrum band.

In some examples, the scheduling manager 1010 may receive an indication that a different UE is scheduled with resources in the first slot using at least the first radio frequency channel allocated for the first uplink communication. In some examples, the scheduling manager 1010 may determine that the different UE has a higher priority for transmission on the first radio frequency channel than the first uplink communication according to the inter-UE multiplexing and prioritization procedure. In some examples, the set of radio frequency channels for the listen before talk procedure include at least the second radio frequency channel, and excludes at least the first radio frequency channel allocated for the first uplink communication.

In some examples, the scheduling manager 1010 may defer the first uplink communication based on the determining that the different UE has the higher priority for transmission on the first radio frequency channel in the first slot.

The RF channel manager 1015 may determine a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication.

In some cases, the set of radio frequency channels is less than all of the radio frequency channels associated with the first uplink communication and the second uplink communication. In some cases, the set of radio frequency channels includes all of the radio frequency channels associated with the first uplink communication and all of the radio frequency channels associated with the second uplink communication.

The LBT manager 1020 may perform a listen before talk procedure to access the set of radio frequency channels in the shared radio frequency spectrum band. In some examples, the LBT manager 1020 may determine, based on the listen before talk procedure, that each frequency channel of the set of radio frequency channels in the shared radio frequency spectrum band is available for transmissions in the first slot.

In some examples, the LBT manager 1020 may transmit the uplink transmission in the first slot using the set of radio frequency channels.

In some examples, the LBT manager 1020 may determine, based on the listen before talk procedure, that one or more frequency channels of the set of radio frequency channels in the shared radio frequency spectrum band is unavailable for transmissions in the first slot. In some examples, the LBT manager 1020 may defer the uplink transmission using the set of radio frequency channels.

In some cases, the first uplink communication is associated with a first listen before talk category and the second uplink communication is associated with a second listen before talk category that has a higher priority than the first listen before talk category. In some cases, the second listen before talk category corresponds to a type 2 channel access procedure within a channel occupancy time (COT) acquired by the base station, and the first listen before talk category corresponds to a type 1 channel access procedure outside of a COT acquired by the base station or associated with a random access transmission.

The multiplexing and prioritization manager 1025 may multiplex the uplink control channel communication with the uplink shared channel communication according to the intra-UE multiplexing and prioritization procedure. In some examples, the set of radio frequency channels include at least the first radio frequency channel allocated for the first uplink communication, and excludes at least the second radio frequency channel.

In some examples, the multiplexing and prioritization manager 1025 may prioritize the uplink control channel communication over the uplink shared channel communication according to the intra-UE multiplexing and prioritization procedure based on the uplink control channel communication being associated with a higher priority communication than the uplink shared channel communication. In some examples, the set of radio frequency channels include at least the second radio frequency channel, and excludes at least the first radio frequency channel allocated for the first uplink communication.

In some examples, the multiplexing and prioritization manager 1025 may prioritize the second uplink communication over the first uplink communication according to an intra-UE prioritization procedure based on the second uplink communication being associated with the higher priority listen before talk category. In some examples, the set of radio frequency channels includes the second radio frequency channel and excludes at least the first radio frequency channel allocated for the first uplink communication.

In some cases, the determining is based on an intra-UE multiplexing and prioritization procedure, an inter-UE multiplexing and prioritization procedure, or combinations thereof. In some cases, the first uplink communication is an uplink shared channel communication and the second uplink communication is an uplink control channel communication.

FIG. 11 shows a diagram of a system 1100 including a device 1105 that supports techniques for transmitting multi-channels in shared radio frequency spectrum in accordance with aspects of the present disclosure. The device 1105 may be an example of or include the components of device 805, device 905, or a UE 115 as described herein. The device 1105 may include components for bi-directional voice and data communications including components for transmitting and receiving communications, including a communications manager 1110, an I/O controller 1115, a transceiver 1120, an antenna 1125, memory 1130, and a processor 1140. These components may be in electronic communication via one or more buses (e.g., bus 1145).

The communications manager 1110 may receive, from a base station, a resource allocation for a first uplink communication in a first slot, where the resource allocation indicates at least a first radio frequency channel in a shared radio frequency spectrum band is allocated for the first uplink communication, identify a second uplink communication that is scheduled in the first slot for transmission using at least a second radio frequency channel in the shared radio frequency spectrum band, determine a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication, and perform a listen before talk procedure to access the set of radio frequency channels in the shared radio frequency spectrum band.

The communications manager 1110 may as described herein be implemented to realize one or more potential advantages. One implementation may allow the device 1105 to perform LBT on a reduced number of channels that are to actually be used for an uplink transmission, which may allow for enhanced likelihood of successful LBT. Further, implementations may allow the device 1105 to reduce the latency of communications, and increase signaling reliability, throughput, and user experience, while reducing power consumption, among other advantages.

The I/O controller 1115 may manage input and output signals for the device 1105. The I/O controller 1115 may also manage peripherals not integrated into the device 1105. In some cases, the I/O controller 1115 may represent a physical connection or port to an external peripheral. In some cases, the I/O controller 1115 may utilize an operating system such as iOS®, ANDROID®, MS-DOS®, MS-WINDOWS®, OS/2®, UNIX®, LINUX®, or another known operating system. In other cases, the I/O controller 1115 may represent or interact with a modem, a keyboard, a mouse, a touchscreen, or a similar device. In some cases, the I/O controller 1115 may be implemented as part of a processor. In some cases, a user may interact with the device 1105 via the I/O controller 1115 or via hardware components controlled by the I/O controller 1115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM and ROM. The memory 1130 may store computer-readable, computer-executable code 1135 including instructions that, when executed, cause the processor to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for transmitting multi-channels in shared radio frequency spectrum).

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

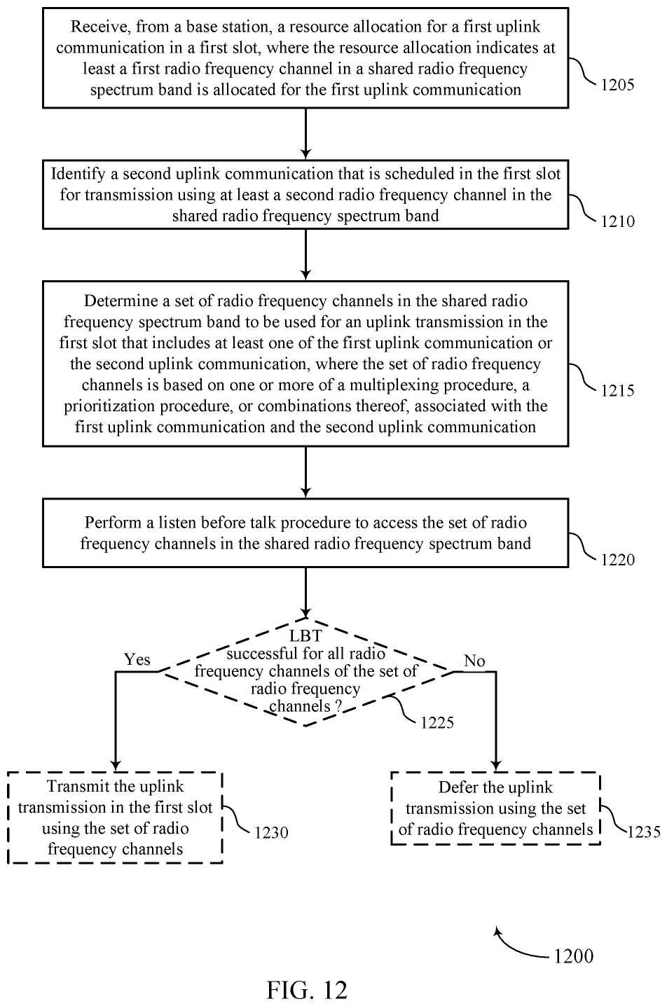

FIG. 12 shows a flowchart illustrating a method 1200 that supports techniques for transmitting multi-channels in shared radio frequency spectrum in accordance with aspects of the present disclosure. The operations of method 1200 may be implemented by a UE 115 or its components as described herein. For example, the operations of method 1200 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1205, the UE may receive, from a base station, a resource allocation for a first uplink communication in a first slot, where the resource allocation indicates at least a first radio frequency channel in a shared radio frequency spectrum band is allocated for the first uplink communication. The operations of 1205 may be performed according to the methods described herein. In some examples, aspects of the operations of 1205 may be performed by a scheduling manager as described with reference to FIGS. 8 through 11.

At 1210, the UE may identify a second uplink communication that is scheduled in the first slot for transmission using at least a second radio frequency channel in the shared radio frequency spectrum band. The operations of 1210 may be performed according to the methods described herein. In some examples, aspects of the operations of 1210 may be performed by a scheduling manager as described with reference to FIGS. 8 through 11.

At 1215, the UE may determine a set of radio frequency channels in the shared radio frequency spectrum band to be used for an uplink transmission in the first slot that includes at least one of the first uplink communication or the second uplink communication, where the set of radio frequency channels is based on one or more of a multiplexing procedure, a prioritization procedure, or combinations thereof, associated with the first uplink communication and the second uplink communication. The operations of 1215 may be performed according to the methods described herein. In some examples, aspects of the operations of 1215 may be performed by a RF channel manager as described with reference to FIGS. 8 through 11.

At 1220, the UE may perform a listen before talk procedure to access the set of radio frequency channels in the shared radio frequency spectrum band. The operations of 1220 may be performed according to the methods described herein. In some examples, aspects of the operations of 1220 may be performed by a LBT manager as described with reference to FIGS. 8 through 11.

Optionally, at 1225, the UE may determine whether the listen before talk procedure was successful for all radio frequency channels of the set of radio frequency channels. The operations of 1225 may be performed according to the methods described herein. In some examples, aspects of the operations of 1225 may be performed by a LBT manager as described with reference to FIGS. 8 through 11.

Optionally, at 1230, if it is determined at 1225 that LBT was successful for all the radio frequency channels of the set of radio frequency channels, the UE may transmit the uplink transmission in the first slot using the set of radio frequency channels. The operations of 1230 may be performed according to the methods described herein. In some examples, aspects of the operations of 1230 may be performed by a LBT manager as described with reference to FIGS. 8 through 11.

Optionally, at 1235, if it is determined at 1225 that LBT was not successful for all the radio frequency channels of the set of radio frequency channels (i.e., LBT failed on one or more of the channels), the UE may defer the uplink transmission using the set of radio frequency channels. The operations of 1240 may be performed according to the methods described herein. In some examples, aspects of the operations of 1240 may be performed by a LBT manager as described with reference to FIGS. 8 through 11.

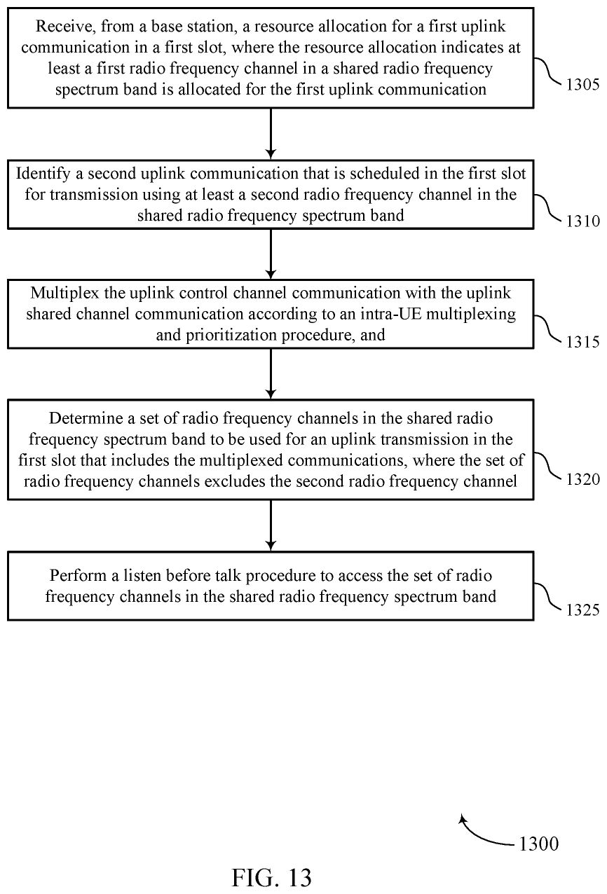

FIG. 13 shows a flowchart illustrating a method 1300 that supports techniques for transmitting multi-channels in shared radio frequency spectrum in accordance with aspects of the present disclosure. The operations of method 1300 may be implemented by a UE 115 or its components as described herein. For example, the operations of method 1300 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1305, the UE may receive, from a base station, a resource allocation for a first uplink communication in a first slot, where the resource allocation indicates at least a first radio frequency channel in a shared radio frequency spectrum band is allocated for the first uplink communication. The operations of 1305 may be performed according to the methods described herein. In some examples, aspects of the operations of 1305 may be performed by a scheduling manager as described with reference to FIGS. 8 through 11.

At 1310, the UE may identify a second uplink communication that is scheduled in the first slot for transmission using at least a second radio frequency channel in the shared radio frequency spectrum band. The operations of 1310 may be performed according to the methods described herein. In some examples, aspects of the operations of 1310 may be performed by a scheduling manager as described with reference to FIGS. 8 through 11. In some cases, the first uplink communication is an uplink shared channel communication and the second uplink communication is an uplink control channel communication.

At 1315, the UE may multiplex the uplink control channel communication with the uplink shared channel communication according to an intra-UE multiplexing and prioritization procedure. The operations of 1315 may be performed according to the methods described herein. In some examples, aspects of the operations of 1315 may be performed by a multiplexing and prioritization manager as described with reference to FIGS. 8 through 11.

At 1320, the UE may determine a set of radio frequency channels in the shared radio frequency spectrum band to be used for an uplink transmission in the first slot that includes the multiplexed communications, where the set of radio frequency channels excludes the second radio frequency channel. The operations of 1320 may be performed according to the methods described herein. In some examples, aspects of the operations of 1320 may be performed by a RF channel manager as described with reference to FIGS. 8 through 11.

At 1325, the UE may perform a listen before talk procedure to access the set of radio frequency channels in the shared radio frequency spectrum band. The operations of 1325 may be performed according to the methods described herein. In some examples, aspects of the operations of 1325 may be performed by a LBT manager as described with reference to FIGS. 8 through 11.

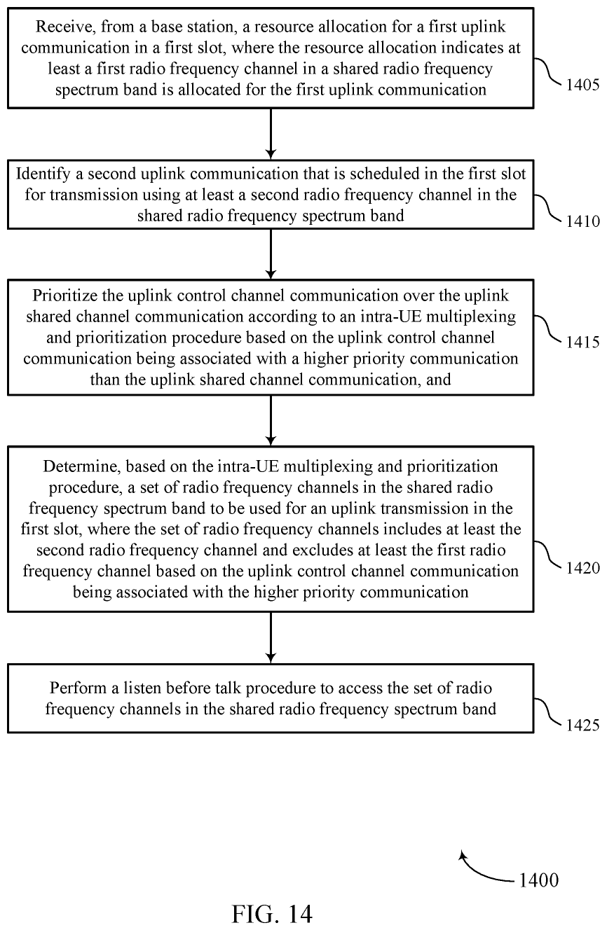

FIG. 14 shows a flowchart illustrating a method 1400 that supports techniques for transmitting multi-channels in shared radio frequency spectrum in accordance with aspects of the present disclosure. The operations of method 1400 may be implemented by a UE 115 or its components as described herein. For example, the operations of method 1400 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1405, the UE may receive, from a base station, a resource allocation for a first uplink communication in a first slot, where the resource allocation indicates at least a first radio frequency channel in a shared radio frequency spectrum band is allocated for the first uplink communication. The operations of 1405 may be performed according to the methods described herein. In some examples, aspects of the operations of 1405 may be performed by a scheduling manager as described with reference to FIGS. 8 through 11.

At 1410, the UE may identify a second uplink communication that is scheduled in the first slot for transmission using at least a second radio frequency channel in the shared radio frequency spectrum band. The operations of 1410 may be performed according to the methods described herein. In some examples, aspects of the operations of 1410 may be performed by a scheduling manager as described with reference to FIGS. 8 through 11. In some cases, the first uplink communication is an uplink shared channel communication and the second uplink communication is an uplink control channel communication.

At 1415, the UE may prioritize the uplink control channel communication over the uplink shared channel communication according to an intra-UE multiplexing and prioritization procedure based on the uplink control channel communication being associated with a higher priority communication than the uplink shared channel communication. The operations of 1415 may be performed according to the methods described herein. In some examples, aspects of the operations of 1415 may be performed by a multiplexing and prioritization manager as described with reference to FIGS. 8 through 11.

At 1420, the UE may determine, based at least in part on the intra-UE multiplexing and prioritization procedure, a set of radio frequency channels in the shared radio frequency spectrum band to be used for an uplink transmission in the first slot, where the set of radio frequency channels includes at least the second radio frequency channel and excludes at least the first radio frequency channel based on the uplink control channel communication being associated with the higher priority communication. The operations of 1420 may be performed according to the methods described herein. In some examples, aspects of the operations of 1420 may be performed by a RF channel manager as described with reference to FIGS. 8 through 11.

At 1425, the UE may perform a listen before talk procedure to access the set of radio frequency channels in the shared radio frequency spectrum band. The operations of 1425 may be performed according to the methods described herein. In some examples, aspects of the operations of 1425 may be performed by a LBT manager as described with reference to FIGS. 8 through 11.

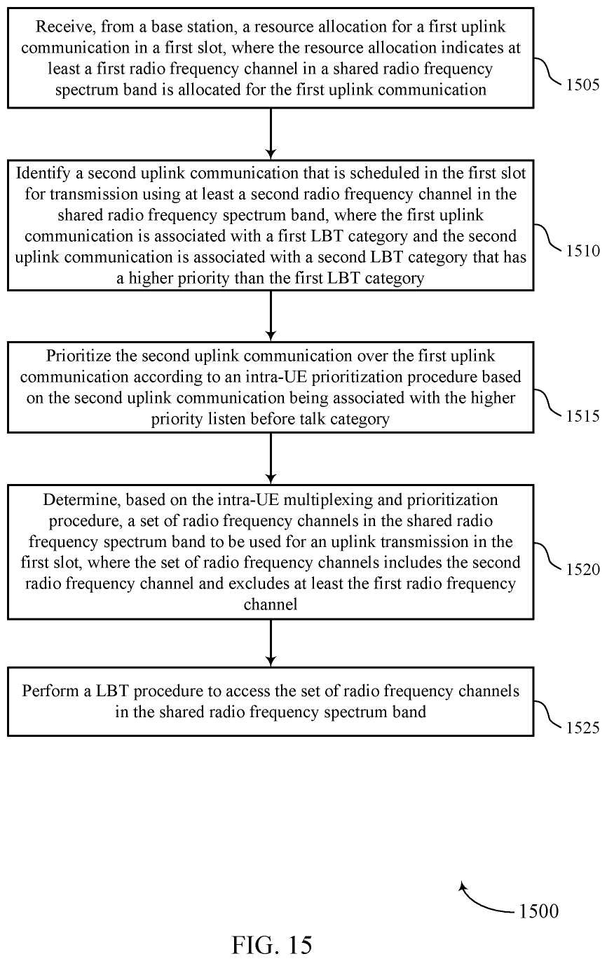

FIG. 15 shows a flowchart illustrating a method 1500 that supports techniques for transmitting multi-channels in shared radio frequency spectrum in accordance with aspects of the present disclosure. The operations of method 1500 may be implemented by a UE 115 or its components as described herein. For example, the operations of method 1500 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1505, the UE may receive, from a base station, a resource allocation for a first uplink communication in a first slot, where the resource allocation indicates at least a first radio frequency channel in a shared radio frequency spectrum band is allocated for the first uplink communication. The operations of 1505 may be performed according to the methods described herein. In some examples, aspects of the operations of 1505 may be performed by a scheduling manager as described with reference to FIGS. 8 through 11.

At 1510, the UE may identify a second uplink communication that is scheduled in the first slot for transmission using at least a second radio frequency channel in the shared radio frequency spectrum band, where the first uplink communication is associated with a first LBT category and the second uplink communication is associated with a second LBT category that has a higher priority than the first LBT category. The operations of 1510 may be performed according to the methods described herein. In some examples, aspects of the operations of 1510 may be performed by a scheduling manager as described with reference to FIGS. 8 through 11.

At 1515, the UE may prioritize the second uplink communication over the first uplink communication according to an intra-UE prioritization procedure based on the second uplink communication being associated with the higher priority listen before talk category. The operations of 1515 may be performed according to the methods described herein. In some examples, aspects of the operations of 1515 may be performed by a multiplexing and prioritization manager as described with reference to FIGS. 8 through 11.

At 1520, the UE may determine, based on the intra-UE multiplexing and prioritization procedure, a set of radio frequency channels in the shared radio frequency spectrum band to be used for an uplink transmission in the first slot, where the set of radio frequency channels includes the second radio frequency channel and excludes at least the first radio frequency channel. The operations of 1520 may be performed according to the methods described herein. In some examples, aspects of the operations of 1520 may be performed by a RF channel manager as described with reference to FIGS. 8 through 11.

At 1525, the UE may perform a listen before talk procedure to access the set of radio frequency channels in the shared radio frequency spectrum band. The operations of 1525 may be performed according to the methods described herein. In some examples, aspects of the operations of 1525 may be performed by a LBT manager as described with reference to FIGS. 8 through 11.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
receiving, from a base station, a resource allocation for a first uplink communication in a first slot, wherein the resource allocation indicates at least a first radio frequency channel in a shared radio frequency spectrum band is allocated for the first uplink communication;
identifying a second uplink communication that is scheduled in the first slot for transmission using at least a second radio frequency channel in the shared radio frequency spectrum band;
determining a set of radio frequency channels in the shared radio frequency spectrum band to be used for an uplink transmission in the first slot that includes at least one of the first uplink communication or the second uplink communication, wherein the set of radio frequency channels is based at least in part on one or more of a multiplexing procedure, a prioritization procedure, or combinations thereof, associated with the first uplink communication and the second uplink communication; and
performing a listen before talk procedure to access the set of radio frequency channels in the shared radio frequency spectrum band.

2. The method of claim 1, further comprising:
determining, based at least in part on the listen before talk procedure, that each frequency channel of the set of radio frequency channels in the shared radio frequency spectrum band is available for transmissions in the first slot; and
transmitting the uplink transmission in the first slot using the set of radio frequency channels.

3. The method of claim 1, further comprising:
determining, based at least in part on the listen before talk procedure, that one or more frequency channels of the set of radio frequency channels in the shared radio frequency spectrum band is unavailable for transmissions in the first slot; and
deferring the uplink transmission using the set of radio frequency channels.

4. The method of claim 1, wherein the set of radio frequency channels is less than all of the radio frequency channels associated with the first uplink communication and the second uplink communication.

5. The method of claim 1, wherein the set of radio frequency channels includes all of the radio frequency channels associated with the first uplink communication and all of the radio frequency channels associated with the second uplink communication.

6. The method of claim 1, wherein the determining is based at least in part on an intra-UE multiplexing and prioritization procedure, an inter-UE multiplexing and prioritization procedure, or combinations thereof.

7. The method of claim 6, wherein the first uplink communication is an uplink shared channel communication and the second uplink communication is an uplink control channel communication.

8. The method of claim 7, further comprising:
multiplexing the uplink control channel communication with the uplink shared channel communication according to the intra-UE multiplexing and prioritization procedure; and
wherein the set of radio frequency channels include at least the first radio frequency channel allocated for the first uplink communication, and excludes at least the second radio frequency channel.

9. The method of claim 7, further comprising:
prioritizing the uplink control channel communication over the uplink shared channel communication according to the intra-UE multiplexing and prioritization procedure based at least in part on the uplink control channel communication being associated with a higher priority communication than the uplink shared channel communication; and
wherein the set of radio frequency channels include at least the second radio frequency channel, and excludes at least the first radio frequency channel allocated for the first uplink communication.

10. The method of claim 6, further comprising:
receiving an indication that a different UE is scheduled with resources in the first slot using at least the first radio frequency channel allocated for the first uplink communication;
determining that the different UE has a higher priority for transmission on the first radio frequency channel than the first uplink communication according to the inter-UE multiplexing and prioritization procedure;
deferring the first uplink communication based at least in part on the determining that the different UE has the higher priority for transmission on the first radio frequency channel in the first slot; and
wherein the set of radio frequency channels for the listen before talk procedure include at least the second radio frequency channel, and excludes at least the first radio frequency channel allocated for the first uplink communication.

11. The method of claim 1, wherein the first uplink communication is associated with a first listen before talk category and the second uplink communication is associated with a second listen before talk category that has a higher priority than the first listen before talk category.

12. The method of claim 11, further comprising:
prioritizing the second uplink communication over the first uplink communication according to an intra-UE prioritization procedure based at least in part on the second uplink communication being associated with the higher priority listen before talk category; and
wherein the set of radio frequency channels includes the second radio frequency channel and excludes at least the first radio frequency channel allocated for the first uplink communication.

13. The method of claim 12, wherein the second listen before talk category corresponds to a type 2 channel access procedure within a channel occupancy time (COT) acquired by the base station, and the first listen before talk category corresponds to a type 1 channel access procedure outside of a COT acquired by the base station or associated with a random access transmission.

14. An apparatus for wireless communication at a user equipment (UE), comprising:
a processor,
memory coupled with the processor; and
instructions stored in the memory and executable by the processor to cause the apparatus to:
receive, from a base station, a resource allocation for a first uplink communication in a first slot, wherein the resource allocation indicates at least a first radio frequency channel in a shared radio frequency spectrum band is allocated for the first uplink communication;
identify a second uplink communication that is scheduled in the first slot for transmission using at least a second radio frequency channel in the shared radio frequency spectrum band;
determine a set of radio frequency channels in the shared radio frequency spectrum band to be used for an uplink transmission in the first slot that includes at least one of the first uplink communication or the second uplink communication, wherein the set of radio frequency channels is based at least in part on one or more of a multiplexing procedure, a prioritization procedure, or combinations thereof, associated with the first uplink communication and the second uplink communication; and
perform a listen before talk procedure to access the set of radio frequency channels in the shared radio frequency spectrum band.

15. The apparatus of claim 14, wherein the instructions are further executable by the processor to cause the apparatus to:
determine, based at least in part on the listen before talk procedure, that each frequency channel of the set of radio frequency channels in the shared radio frequency spectrum band is available for transmissions in the first slot; and
transmit the uplink transmission in the first slot using the set of radio frequency channels.

16. The apparatus of claim 14, wherein the instructions are further executable by the processor to cause the apparatus to:
determine, based at least in part on the listen before talk procedure, that one or more frequency channels of the set of radio frequency channels in the shared radio frequency spectrum band is unavailable for transmissions in the first slot; and
defer the uplink transmission using the set of radio frequency channels.

17. The apparatus of claim 14, wherein the set of radio frequency channels is less than all of the radio frequency channels associated with the first uplink communication and the second uplink communication.

18. The apparatus of claim 14, wherein the set of radio frequency channels includes all of the radio frequency channels associated with the first uplink communication and all of the radio frequency channels associated with the second uplink communication.

19. The apparatus of claim 14, wherein the determining is based at least in part on an intra-UE multiplexing and prioritization procedure, an inter-UE multiplexing and prioritization procedure, or combinations thereof.

20. The apparatus of claim 19, wherein the first uplink communication is an uplink shared channel communication and the second uplink communication is an uplink control channel communication.

21. The apparatus of claim 20, wherein the instructions are further executable by the processor to cause the apparatus to:
multiplex the uplink control channel communication with the uplink shared channel communication according to the intra-UE multiplexing and prioritization procedure; and
wherein the set of radio frequency channels include at least the first radio frequency channel allocated for the first uplink communication, and excludes at least the second radio frequency channel.

22. The apparatus of claim 20, wherein the instructions are further executable by the processor to cause the apparatus to:
prioritize the uplink control channel communication over the uplink shared channel communication according to the intra-UE multiplexing and prioritization procedure based at least in part on the uplink control channel communication being associated with a higher priority communication than the uplink shared channel communication; and
wherein the set of radio frequency channels include at least the second radio frequency channel, and excludes at least the first radio frequency channel allocated for the first uplink communication.

23. The apparatus of claim 19, wherein the instructions are further executable by the processor to cause the apparatus to:
receive an indication that a different UE is scheduled with resources in the first slot using at least the first radio frequency channel allocated for the first uplink communication;
determine that the different UE has a higher priority for transmission on the first radio frequency channel than the first uplink communication according to the inter-UE multiplexing and prioritization procedure;
defer the first uplink communication based at least in part on the determining that the different UE has the higher priority for transmission on the first radio frequency channel in the first slot; and
wherein the set of radio frequency channels for the listen before talk procedure include at least the second radio frequency channel, and excludes at least the first radio frequency channel allocated for the first uplink communication.

24. The apparatus of claim 14, wherein the first uplink communication is associated with a first listen before talk category and the second uplink communication is associated with a second listen before talk category that has a higher priority than the first listen before talk category.

25. The apparatus of claim 24, wherein the instructions are further executable by the processor to cause the apparatus to:
prioritize the second uplink communication over the first uplink communication according to an intra-UE prioritization procedure based at least in part on the second uplink communication being associated with the higher priority listen before talk category; and
wherein the set of radio frequency channels includes the second radio frequency channel and excludes at least the first radio frequency channel allocated for the first uplink communication.

26. The apparatus of claim 25, wherein the second listen before talk category corresponds to a type 2 channel access procedure within a channel occupancy time (COT) acquired by the base station, and the first listen before talk category corresponds to a type 1 channel access procedure outside of a COT acquired by the base station or associated with a random access transmission.

27. An apparatus for wireless communication at a user equipment (UE), comprising:
means for receiving, from a base station, a resource allocation for a first uplink communication in a first slot, wherein the resource allocation indicates at least a first radio frequency channel in a shared radio frequency spectrum band is allocated for the first uplink communication;
means for identifying a second uplink communication that is scheduled in the first slot for transmission using at least a second radio frequency channel in the shared radio frequency spectrum band;
means for determining a set of radio frequency channels in the shared radio frequency spectrum band to be used for an uplink transmission in the first slot that includes at least one of the first uplink communication or the second uplink communication, wherein the set of radio frequency channels is based at least in part on one or more of a multiplexing procedure, a prioritization procedure, or combinations thereof, associated with the first uplink communication and the second uplink communication; and
means for performing a listen before talk procedure to access the set of radio frequency channels in the shared radio frequency spectrum band.

28. The apparatus of claim 27, further comprising:
means for determining, based at least in part on the listen before talk procedure, that each frequency channel of the set of radio frequency channels in the shared radio frequency spectrum band is available for transmissions in the first slot; and
means for transmitting the uplink transmission in the first slot using the set of radio frequency channels.

29. The apparatus of claim 27, further comprising:
means for determining, based at least in part on the listen before talk procedure, that one or more frequency channels of the set of radio frequency channels in the shared radio frequency spectrum band is unavailable for transmissions in the first slot; and
means for deferring the uplink transmission using the set of radio frequency channels.

30. A non-transitory computer-readable medium storing code for wireless communication at a user equipment (UE), the code comprising instructions executable by a processor to:
receive, from a base station, a resource allocation for a first uplink communication in a first slot, wherein the resource allocation indicates at least a first radio frequency channel in a shared radio frequency spectrum band is allocated for the first uplink communication;
identify a second uplink communication that is scheduled in the first slot for transmission using at least a second radio frequency channel in the shared radio frequency spectrum band;
determine a set of radio frequency channels in the shared radio frequency spectrum band to be used for an uplink transmission in the first slot that includes at least one of the first uplink communication or the second uplink communication, wherein the set of radio frequency channels is based at least in part on one or more of a multiplexing procedure, a prioritization procedure, or combinations thereof, associated with the first uplink communication and the second uplink communication; and
perform a listen before talk procedure to access the set of radio frequency channels in the shared radio frequency spectrum band.
